(19) United States
(12) Patent Application Publication
(10) Pub. No.: US 2025/0139050 A1
(43) Pub. Date: May 1, 2025

(54) FLEET MANAGEMENT SYSTEM

(71) Applicant: TBL Technologies, Inc., New York, NY (US)

(72) Inventors: Dylan Feeney, New York, NY (US); Eli Johnson, New York, NY (US)

(21) Appl. No.: 18/901,691

(22) Filed: Sep. 30, 2024

Related U.S. Application Data
(60) Provisional application No. 63/545,723, filed on Oct. 25, 2023.

(51) Int. Cl. G06F 13/42; G06F 13/38

(52) U.S. Cl. CPC G06F 13/4282; G06F 13/382; G06F 2213/0042

(57) ABSTRACT

Systems and methods herein describe a fleet management system. The fleet management system identifies gateway device and transmits configuration data to the gateway device using message queuing telemetry transport (MQTT). The configuration data includes information about internet of things (IoT) devices located in a building. The fleet management system receives status data of the IoT devices from the gateway device and generates control data for controlling operation of the IoT devices. The control data is transmitted to the gateway device using MQTT and the gateway device transmits the control data to the IoT devices. The fleet management system receives an indication from the gateway device that operation of the IoT devices has been modified using the control data.

### CLAIM OF PRIORITY

The present application claims priority to U.S. Provisional Patent Application Ser. No. 63/545,723, filed Oct. 25, 2023, which is incorporated herein by reference in its entirety.

### TECHNICAL FIELD

Systems and methods herein describe device management software and hardware. More particularly, but not by way of limitations, examples herein describe a fleet management system for monitoring and controlling Internet of Things (IoT) devices.

### BACKGROUND

Advancements in technology have given rise to the Internet of Things (IoT), a network of interconnected physical devices that communicate and exchange data. IoT devices have transformed living spaces by enhancing convenience, efficiency and security.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a fleet management system in accordance with one example.

FIG. 2 is a flowchart of a process for transmitting data between a gateway device and a fleet management server system, in accordance with one example.

FIG. 3 is a diagrammatic representation of a machine in the form of a computer system within which a set of instructions may be executed to cause the machine to perform any one or more of the methodologies discussed herein, according to some examples.

FIG. 4 is a block diagram showing a software architecture within which examples may be implemented.

### DETAILED DESCRIPTION

The process from installing an IoT device to visualizing the data on a software application can be quite complex. A wide range of technical knowledge is required, such as understanding hardware, telecommunications, networking, and various cloud concepts. Solutions herein describe a hardware and software solution that simplifies this entire process.

Most building structures have systems such as lighting systems and heating, ventilation, and air conditioning (HVAC) systems that operate to maintain the health and comfort of occupants in the building. An IoT device, such as a smart lightbulb, temperature sensor, or a smart thermostat can be used to monitor systems and intelligently control systems.

The paragraphs below describe a fleet management system. The fleet management system can efficiently and effectively control IoT devices to improve the performance of the devices and allow users optimize usage of their IoT devices. Data from the IoT devices can be collected on-site via a gateway device. The IoT devices can communicate with the gateway device using different communication protocols. The communication protocols can be wired or wireless.

The gateway device translates data received from the IoT devices into message queuing telemetry transport (MQTT) payloads and sends the payloads to a fleet management system. The fleet management system can generate control instructions for the IoT devices, and these control instructions can be transmitted via the gateway device. While the communication protocol between the gateway device and the fleet management system is described to be MQTT, it is to be understood that any suitable communication protocol may be used (e.g., constrained application protocol (CoAP)). Further details of the fleet management system and the gateway device are described below.

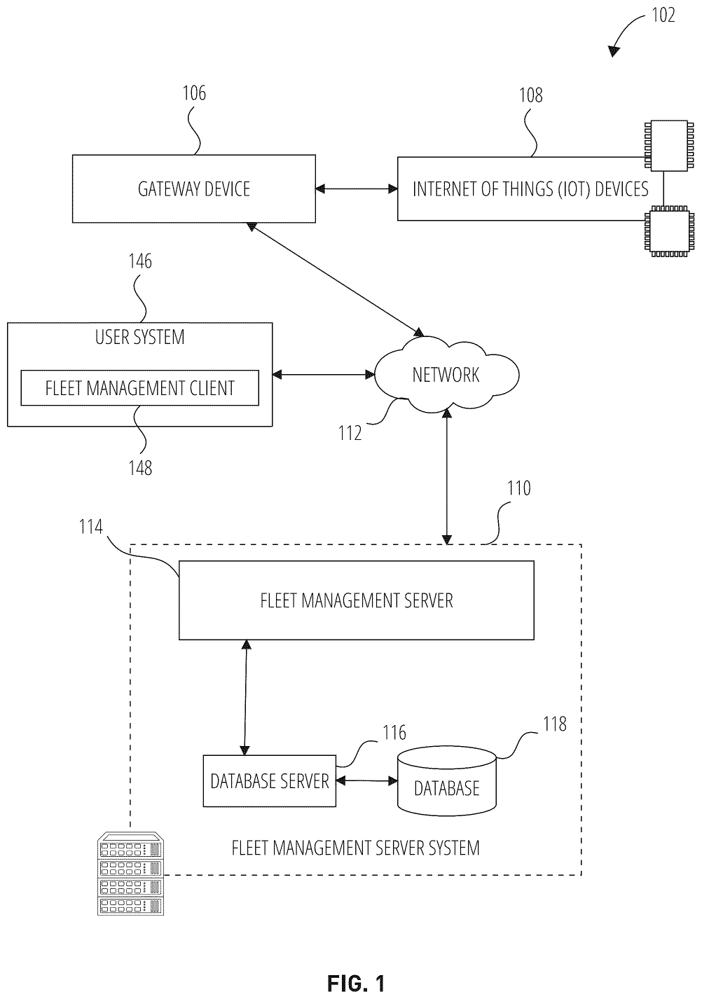

FIG. 1 is a block diagram showing an example fleet management system 102 for receiving and sending IoT device data (e.g., instructions, configurations) over a network. The fleet management system 102 includes at least one gateway device 106, each of which is communicatively coupled, via one or more communication networks including a network 112 (e.g., the Internet), to a set of Internet of Things (IoT) devices 108. The gateway device 106 is configured to send and receive data from each of the IoT devices 108. The data exchanged between the gateway device 106 and the IoT devices 108 includes status information collected by the loT devices 108, device information of the IoT devices 108 and control information sent by the gateway device 106 to the IoT devices 108 that is used to change or modify operation of the IoT devices 108.

Each user system 146 may include multiple user devices, such as a mobile device, and a computer client device that are communicatively connected to exchange data and messages. A fleet management client 148 interacts with the fleet management server system 110 via the network 112. The data exchanged between the fleet management client 148 and the fleet management server system 110 includes functions (e.g., commands to invoke functions) and payload data (e.g., control data, status data, security updates, firmware over-the-air (FOTA) updates, diagnostics).

The fleet management server system 110 provides server-side functionality via the network 112 to the fleet management client 148. While certain functions of the fleet management system 102 are described herein as being performed by either the fleet management client 148 or by the fleet management server system 110, the location of certain functionality either within the fleet management client 148 or the fleet management server system 110 may be a design choice. For example, it may be technically preferable to initially deploy particular technology and functionality within the fleet management server system 110 but to later migrate this technology and functionality to the fleet management client 148.

The fleet management server system 110 supports various services and operations that are provided to the fleet management client 148. Such operations include transmitting data to, receiving data from, and processing data generated by the gateway device 106. This data may include sensor data collected from the IoT devices 108, device information of the IoT devices 108, and control data to modify operation of the IoT devices 108.

The fleet management server system 110 makes the functions of the fleet management server 114 accessible to the fleet management client 148. The fleet management server 114 is communicatively coupled to a database server 116, facilitating access to a database 118 that stores data associated with data exchanges processed by the fleet management server 114.

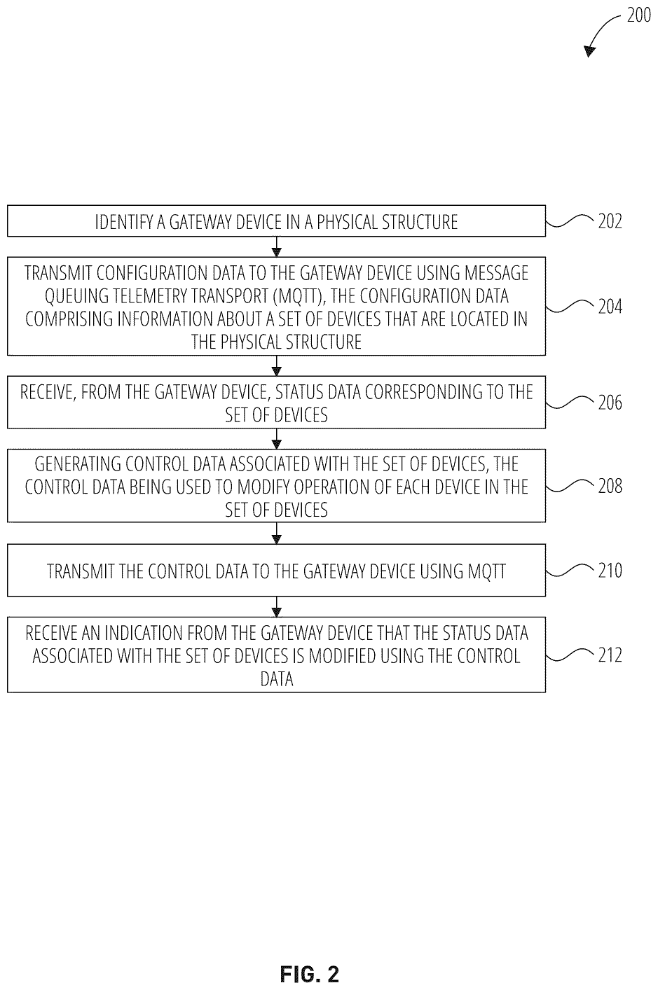

FIG. 2 illustrates a process 200 for transmitting data between a gateway device and a fleet management system, in accordance with one example. In one example, the processor in a gateway device 106, the processor in a fleet management server system 110, the processor in a user system 146, the processor in a fleet management client 148, the processor in the IoT devices 108, or any combination thereof, can perform the operations in process 200.

In operation 202, the processor identifies a gateway device 106 in a physical structure. The physical structure can be any building structure such as a residential home, a commercial building, an educational facility, or an entertainment venue. The gateway device 106, the fleet management server system 110, and the user system 146 are communicatively linked to an MQTT broker. In an MQTT architecture, a client may be a publisher, a subscriber or both. Instead of communicating with each other directly, by using the MQTT protocol, the clients communicate with an MQTT broker (e.g., a server). For example, the MQTT clients can include one or more of the gateway device 106, the fleet management server 114, and a user system 146. The broker can receive communication from one client and transmit the communication to other clients. The gateway device 106 can be identified using a communication by the MQTT broker to at least one of the fleet management server system 110 or user system 146.

In operation 204, the processor transmits configuration data to the gateway device 106 using MQTT. The configuration data comprises information about a set of devices (e.g., IoT devices 108) that are in the physical structure. The configuration data is generated by an operator of the fleet management client 148. The operator of the fleet management client 148 does not have to have physical access to the gateway device 106 to configure the device. The configuration data is remotely transmitted to the gateway device 106 from a location different from the physical structure.

The operator can also send Firmware Over-The-Air (FOTA) updates for up-to-date security, performance, compatibility, and configuration updates remotely from a user interface of the fleet management client 148 to the gateway device 106. The operator can further ping the gateway device 106 and IoT devices 108, run diagnostics on the IoT devices 108, and request data from the IoT devices 108 and the gateway device 106.

When the gateway device 106 receives the configuration data from the fleet management server 114, the gateway device 106 will be aware of which data types to expect from the set of IoT devices 108. The gateway device 106 can either wait for the incoming data to arrive or can poll for the data.

Specifically, the gateway device 106 is subscribed to various MQTT “topics” on the MQTT broker which allows the gateway device 106 to receive data from the fleet management server system 110. Messages sent using the MQTT protocol are published to “topics”. The topics define a structure (e.g., similar to that of a directory tree in a computer file system) that allow only certain subscriber clients to access data of that topic.

In some examples, the gateway device 106 can initiate retrieval of the configuration data from the fleet management server 114. In another example, the gateway device 106 can identify devices (e.g., the loT devices 108) that are communicatively connected to it. Identifying the devices includes determining the data formats associated with each of the devices. The gateway device 106 can identify the devices using a device library. The gateway device 106 can generate configuration data based on the identified devices and transmit the recommendation to the fleet management server 114. In some examples, the transmitted configuration data is validated by a user of the fleet management client 148.

The configuration data includes information about the IoT device 108 that are located in the physical structure. The configuration data includes device provisioning data which entails the initial device configuration to modify the IoT device from its original, off-the-shelf settings to those required for the device to be integrated into the fleet management system. The configuration data also includes updates to firmware, networking data, access permissions and other device properties of the IoT device. The gateway device 106 can either wait to receive data from the IoT devices 108 or poll for data from the IoT devices 108. The gateway device 106 identifies a communication protocol associated with the IoT devices 108, receives status data from the IoT device using the communication protocol, and transmits the status data to the fleet management server. In some examples, the status data is transmitted to the fleet management server via MQTT. The gateway device 106 receives control data to modify the status data of the IoT devices 108 via MQTT and transmits the control data to the IoT devices 108 using the communication protocol that each IoT device of the IoT devices 108 supports. The communication protocol can be a different protocol from MQTT.

In operation 206, the processor receives from the gateway device 106, status data corresponding to the set of devices (IoT devices 108). The status data is a real-time or near real-time status of sensor data or system data associated with the IoT devices 108. For example, if an IoT device in the set of IoT devices 108 is a temperature sensor, the status data can include a temperature value, a temperature unit of measurement, a humidity value, and a humidity unit of measurement. The status data can also include device-related information such as a communication protocol used by the sensor, manufacturer information, model identification value, and other device-related information that can be used to uniquely identify the IoT temperature sensor. Specifically, the processor receives a set of MQTT payloads from the gateway device 106. Each MQTT payload in the set of MQTT payloads describes the status data and the device information of each device in the set of devices. The status data can be stored in a database 118.

In operation 208, the processor generates control data associated with the set of devices, the control data being used to modify operation of the IoT devices 108. For example, the control data can be used to change the functioning of one or more sensors and systems of the IoT devices 108. The control data can be user-generated control strategies. An operator of the fleet management client 148 can define various constraints to apply on the set of devices via a user interface available from the fleet management client 148. For example, a user can increase or reduce the temperature settings on a smart thermostat based on the time of day or occupancy level of the physical structure. In another example, there may be a smart thermostat controlling an air handling unit that supplies cool air to five different rooms. Each of these five rooms may have their own IoT temperature sensor. If the operator wanted to deploy a “Weighted Zone” control strategy, then they would define a weight for each of the five rooms. Rooms may be weighted differently in different scenarios. One scenario could be that room A is a larger office, so the operator may want to weigh the sensor for room A at 80% and the remaining four sensors at 5% each. The gateway device 106 can thus calculate the correct control data that it should send to the air handling unit based on each room's weight. In some examples, the fleet management server system 110 can calculate the correct control data.

The control data can also be automatically generated based on an analysis of historical data (e.g., historical status data). For example, based on an analysis of the IoT devices 108 behavior, the fleet management server 114 can use a machine learning model to analyze previous status data to optimize the operation of the IoT devices 108. In another example, if occupancy sensors are mapped to a particular system such as a lighting system, then the fleet management server 114 can understand occupied and unoccupied times of day and days of the week. With this information, the lighting system can be automatically controlled without the user of a user-generated control strategy (e.g., a timed schedule). In another example, the automatically generated control data can be provided to the operator of the fleet management client 148 as a recommendation with some information as to what may happen if the recommended control strategy was implemented. For example, a notification may appear on the graphical user interface of the fleet management client 148 that states the amount of money that can be saved if a specific strategy was implemented for an extra hour each day on business days. In some examples, the processor causes display of the status data and the control data on a graphical user interface of a computing device (e.g., of a user system 146).

In operation 210, the processor transmits the control data to the gateway device 106 using MQTT. The control data is transmitted in the form of a standardized MQTT payload. In operation 212, the processor receives an indication from the gateway device 106 that the status data associated with the set of IoT devices 108 is modified using the control data. For example, the gateway device 106 transmits the control data to the IoT devices 108 and can receive updated status data from the IoT devices 108. In response to receiving the updated status data from the IoT devices 108, the gateway device 106 can generate and transmit a notification to the processor that indicates that the control data was successfully transmitted to the loT devices 108 and the status data of the IoT devices 108 has now been updated based on the control data.

In some examples, after the gateway device 106 receives the control data, the gateway device 106 must translate the MQTT payload that includes the control data to the communication protocols supported by each of the IoT devices 108 in order to transmit the control data to the IoT devices 108. Each IoT device in the set of IoT devices 108 may utilize a different communication protocol (BACnet, Modbus, MQTT, LoRaWAN, etc.). The gateway device 106 is responsible for translating the MQTT payload with the control data into the specific communication protocol utilized by each IoT device in the set of IoT devices 108.

In some examples, the gateway device 106 includes at least one of a core processing unit, an ethernet controlling unit, a supercapacitor unit, a universal series bus (USB) port, and a serial driver unit. In some examples, the gateway device 106 further includes a cellular modem unit. The core processing unit comprises a microcontroller. In some examples, the microcontroller is an ESP32 microcontroller. The USB port is configured to provide a virtual serial interface for programming and configuration. The serial driver is configured to translate MQTT payloads to device-specific data of the Internet of Things (IoT) devices 108.

### Machine Architecture

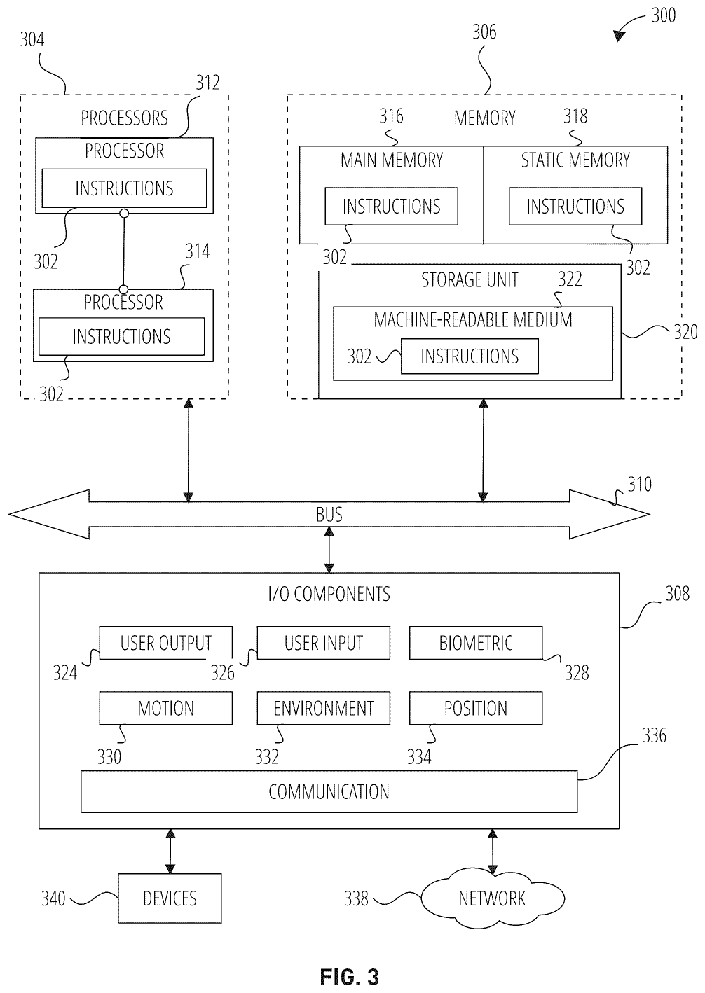

FIG. 3 is a diagrammatic representation of the machine 300 within which instructions 302 (e.g., software, a program, an application, an applet, an app, or other executable code) for causing the machine 300 to perform any one or more of the methodologies discussed herein may be executed. For example, the instructions 302 may cause the machine 300 to execute any one or more of the methods described herein. The instructions 302 transform the general, non-programmed machine 300 into a particular machine 300 programmed to carry out the described and illustrated functions in the manner described. The machine 300 may operate as a standalone device or may be coupled (e.g., networked) to other machines. In a networked deployment, the machine 300 may operate in the capacity of a server machine or a client machine in a server-client network environment, or as a peer machine in a peer-to-peer (or distributed) network environment. The machine 300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 302, sequentially or otherwise, that specify actions to be taken by the machine 300. Further, while a single machine 300 is illustrated, the term “machine” shall also be taken to include a collection of machines that individually or jointly execute the instructions 302 to perform any one or more of the methodologies discussed herein. The machine 300, for example, may comprise the user system 146 or any one of multiple server devices forming part of the fleet management server system 110. In some examples, the machine 300 may also comprise both client and server systems, with certain operations of a particular method or algorithm being performed on the server-side and with certain operations of the particular method or algorithm being performed on the client-side.

The machine 300 may include processors 304, memory 306, and input/output I/O components 308, which may be configured to communicate with each other via a bus 310. In an example, the processors 304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 312 and a processor 314 that execute the instructions 302. The term “processor” is intended to include multi-core processors that may comprise two or more independent processors (sometimes referred to as “cores”) that may execute instructions contemporaneously. Although FIG. 3 shows multiple processors 304, the machine 300 may include a single processor with a single-core, a single processor with multiple cores (e.g., a multi-core processor), multiple processors with a single core, multiple processors with multiples cores, or any combination thereof.

The memory 306 includes a main memory 316, a static memory 318, and a storage unit 320, both accessible to the processors 304 via the bus 310. The main memory 306, the static memory 318, and storage unit 320 store the instructions 302 embodying any one or more of the methodologies or functions described herein. The instructions 302 may also reside, completely or partially, within the main memory 316, within the static memory 318, within machine-readable medium 322 within the storage unit 320, within at least one of the processors 304 (e.g., within the processor's cache memory), or any suitable combination thereof, during execution thereof by the machine 300.

The I/O components 308 may include a wide variety of components to receive input, provide output, produce output, transmit information, exchange information, capture measurements, and so on. The specific I/O components 308 that are included in a particular machine will depend on the type of machine. For example, portable machines such as mobile phones may include a touch input device or other such input mechanisms, while a headless server machine will likely not include such a touch input device. It will be appreciated that the I/O components 308 may include many other components that are not shown in FIG. 3. In various examples, the I/O components 308 may include user output components 324 and user input components 326. The user output components 324 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 326 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 308 may include biometric components 328, motion components 330, environmental components 332, or position components 334, among a wide array of other components.

The motion components 330 include acceleration sensor components (e.g., accelerometer), gravitation sensor components, rotation sensor components (e.g., gyroscope).

The environmental components 332 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

The position components 334 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 308 further include communication components 336 operable to couple the machine 300 to a network 338 or devices 340 via respective coupling or connections. For example, the communication components 336 may include a network interface component or another suitable device to interface with the network 338. In further examples, the communication components 336 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 340 may be another machine or any of a wide variety of peripheral devices (e.g., a peripheral device coupled via a USB).

Moreover, the communication components 336 may detect identifiers or include components operable to detect identifiers. For example, the communication components 336 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 336, such as location via Internet Protocol (IP) geolocation, location via Wi-Fi® signal triangulation, location via detecting an NFC beacon signal that may indicate a particular location, and so forth.

The various memories (e.g., main memory 316, static memory 318, and memory of the processors 304) and storage unit 320 may store one or more sets of instructions and data structures (e.g., software) embodying or used by any one or more of the methodologies or functions described herein. These instructions (e.g., the instructions 302), when executed by processors 304, cause various operations to implement the disclosed examples.

The instructions 302 may be transmitted or received over the network 338, using a transmission medium, via a network interface device (e.g., a network interface component included in the communication components 336) and using any one of several well-known transfer protocols (e.g., hypertext transfer protocol (HTTP)). Similarly, the instructions 302 may be transmitted or received using a transmission medium via a coupling (e.g., a peer-to-peer coupling) to the devices 340.

### Software Architecture

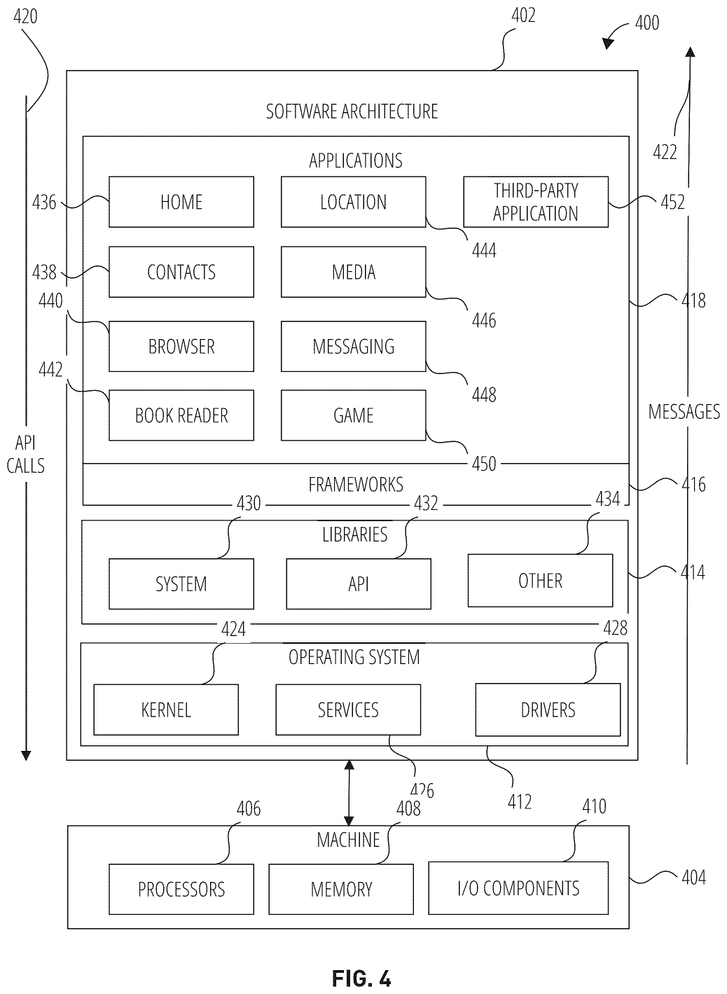

FIG. 4 is a block diagram 400 illustrating a software architecture 402, which can be installed on any one or more of the devices described herein. The software architecture 402 is supported by hardware such as a machine 404 that includes processors 406, memory 408, and I/O components 410. In this example, the software architecture 402 can be conceptualized as a stack of layers, where each layer provides a particular functionality. The software architecture 402 includes layers such as an operating system 412, libraries 414, frameworks 416, and applications 418. Operationally, the applications 418 invoke API calls 420 through the software stack and receive messages 422 in response to the API calls 420.

The operating system 412 manages hardware resources and provides common services. The operating system 412 includes, for example, a kernel 424, services 426, and drivers 428. The kernel 424 acts as an abstraction layer between the hardware and the other software layers. For example, the kernel 424 provides memory management, processor management (e.g., scheduling), component management, networking, and security settings, among other functionalities. The services 426 can provide other common services for the other software layers. The drivers 428 are responsible for controlling or interfacing with the underlying hardware. For instance, the drivers 428 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 414 provide a common low-level infrastructure used by the applications 418. The libraries 414 can include system libraries 430 (e.g., C standard library) that provide functions such as memory allocation functions, string manipulation functions, mathematic functions, and the like. In addition, the libraries 414 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 414 can also include a wide variety of other libraries 434 to provide many other APIs to the applications 418.

The frameworks 416 provide a common high-level infrastructure that is used by the applications 418. For example, the frameworks 416 provide various graphical user interface (GUI) functions, high-level resource management, and high-level location services. The frameworks 416 can provide a broad spectrum of other APIs that can be used by the applications 418, some of which may be specific to a particular operating system or platform.

In an example, the applications 418 may include a home application 436, a contacts application 438, a browser application 440, a book reader application 442, a location application 444, a media application 446, a messaging application 448, a game application 450, and a broad assortment of other applications such as a third-party application 452. The applications 418 are programs that execute functions defined in the programs. Various programming languages can be employed to create one or more of the applications 418, structured in a variety of manners, such as object-oriented programming languages (e.g., Objective-C, Java, or C++) or procedural programming languages (e.g., C or assembly language). In a specific example, the third-party application 452 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 452 can invoke the API calls 420 provided by the operating system 412 to facilitate functionalities described herein.

### GLOSSARY

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A method comprising:
identifying a gateway device in a physical structure;
transmitting configuration data to the gateway device using message queuing telemetry transport (MQTT), the configuration data comprising information about a set of devices that are located in the physical structure;
receiving, from the gateway device, status data corresponding to the set of devices;
generating control data associated with the set of devices, the control data being used to modify operation of each device in the set of devices;
transmitting the control data to the gateway device using MQTT; and
receiving an indication from the gateway device that the status data associated with the set of devices is modified using the control data.

2. The method of claim 1, further comprising:
causing display of the status data and the control data on a graphical user interface of a computing device.

3. The method of claim 1, wherein each device in the set of devices is an IoT device.

4. The method of claim 1, wherein the control data is generated based on user-generated control strategies.

5. The method of claim 1, wherein the configuration data is remotely transmitted to the gateway device from a location different than the physical structure.

6. The method of claim 1, wherein the control data is automatically generated based on an analysis of historical status data.

7. The method of claim 1, wherein receiving the status data further comprises:
receiving a set of MQTT payloads from the gateway device, each MQTT payload in the set of MQTT payloads describing device information of each device in the set of devices.

8. The method of claim 7, wherein for each device, the device information comprises a communication protocol associated with the device.

9. A gateway device comprising:
a core processing unit;
an ethernet controller unit;
a supercapacitor unit;
a universal series bus (USB) port; and
a serial driver unit.

10. The gateway device of claim 9, wherein the core processing unit comprises an ESP32 microcontroller.

11. The gateway device of claim 9, wherein the USB port is configured to provide a virtual serial interface.

12. The gateway device of claim 9, wherein the serial driver is configured to translate MQTT payloads to device-specific data.

13. The gateway device of claim 9, configured to perform operations comprising:
receiving configuration data from a server, the configuration data comprising information about an IoT device that is located in a physical structure; and
polling for data from the IoT device.

14. The gateway device of claim 13, configured to perform operations comprising:
identifying a communication protocol associated with the IoT device;
receiving status data from the IoT device using the communication protocol; and
transmitting the status data to a server using MQTT.

15. The gateway device of claim 14, configured to perform operations comprising:
receiving control data to modify the status data of the IoT device via MQTT; and
transmitting the control data to the IoT device using the communication protocol, wherein the communication protocol is a different protocol from MQTT.

16. A non-transitory computer-readable storage medium storing instructions, that, when executed by at least one processor, causes at least one processor to perform operations comprising:
identifying a gateway device in a physical structure;
transmitting configuration data to the gateway device using message queuing telemetry transport (MQTT), the configuration data comprising information about a set of devices that are located in the physical structure;
receiving, from the gateway device, status data corresponding to the set of devices;
generating control data associated with the set of devices, the control data being used to modify operation of each device in the set of devices;
transmitting the control data to the gateway device using MQTT; and
receiving an indication from the gateway device that the status data associated with the set of devices is modified using the control data.

17. The non-transitory computer-readable storage medium of claim 16, wherein each device in the set of devices is an IoT device.

18. The non-transitory computer-readable storage medium of claim 16, wherein the control data is generated based on user-generated control strategies.

19. The non-transitory computer-readable storage medium of claim 16, wherein the control data is automatically generated based on an analysis of historical status data.

20. The non-transitory computer-readable storage medium of claim 16, wherein the configuration data is remotely transmitted to the gateway device from a location different than the physical structure.
